(19) United States
(12) Patent Application Publication
(10) Pub. No.: US 2025/0037016 A1
(43) Pub. Date: Jan. 30, 2025

(54) MACHINE LEARNING APPARATUS, METHOD AND STORAGE MEDIUM

(71) Applicant: KABUSHIKI KAISHA TOSHIBA, Tokyo (JP)

(72) Inventors: Yasutaka FURUSHO, Fuchu Tokyo (JP); Shuhei NITTA, Tokyo (JP)

(73) Assignee: KABUSHIKI KAISHA TOSHIBA, Tokyo (JP)

(21) Appl. No.: 18/591,187

(22) Filed: Feb. 29, 2024

(30) Foreign Application Priority Data
Jul. 24, 2023 (JP) 2023-120001

(51) Int. Cl. G06N 20/00

(52) U.S. Cl. CPC G06N 20/00

(57) ABSTRACT

According to one embodiment, a machine learning apparatus includes processing circuitry. The processing circuitry acquires a training sample including an object sample and a target value correlated with the object sample. The processing circuitry generates a first augmented sample by applying data augmentation to the object sample in accordance with a first data augmentation parameter. The processing circuitry generates a parameter output function that inputs therein the object sample and outputs a second data augmentation parameter corresponding to the object sample, by machine learning based on the object sample, the target value and the first augmented sample.

### CROSS-REFERENCE TO RELATED APPLICATION

This application is based upon and claims the benefit of priority from prior Japanese Patent Application No. 2023-120001, filed Jul. 24, 2023, the entire contents of which are incorporated herein by reference.

### FIELD

Embodiments described herein relate generally to a machine learning apparatus, method and storage medium.

### BACKGROUND

Data augmentation is used for training of a machine learning model that predicts a target value from an object sample (hereinafter referred to as “target value prediction model”). The data augmentation is a method in which, for example, in a case where an object sample is an image, the diversity of data is enhanced by applying “some kind of transformation” to the object sample, such as by rotating, enlarging or reducing the image. To enhance the diversity of data is important since this leads to generalization of the target value prediction model that is trained. It is desirable that the data augmentation be data transformation that is invariable in regard to a target value of a task of the target value prediction model. For example, in a case where the task is a class classification of images, it is desirable that the data augmentation be data transformation that is invariable in regard to an image class.

Patent Literature 1 (Jpn. Pat. Appln. KOKAI Publication No. 2020-140466) discloses that a plurality of candidates of data augmentation parameters, such as a rotation angle and an enlargement ratio of an image, are prepared, and an augmented sample is generated for each candidate. In regard to a trained model by original samples to which data augmentation is not applied, a score (for example, accuracy) of each augmented sample and a score of other samples than the original samples are examined, and a data augmentation parameter, which achieves a score falling within a predetermined range from the score of the other samples, is adopted.

### BRIEF DESCRIPTION OF THE DRAWINGS

FIG. 1 is a diagram illustrating a configuration example of a machine learning apparatus according to an embodiment.

FIG. 2 is a diagram illustrating an example of an object sample and a target value.

FIG. 3 is a diagram illustrating an input-output relationship of a parameter output function.

FIG. 4 is a diagram illustrating an input-output relationship of a target value prediction model.

FIG. 5 is a diagram illustrating a processing procedure of a machine learning process according to the embodiment.

FIG. 6 is a diagram schematically illustrating a training aspect of a parameter output function in steps S1 to S4 of FIG. 5.

FIG. 7 is a diagram schematically illustrating a training aspect of a target value prediction model in steps S5 to S8 of FIG. 5.

FIG. 8 is a diagram illustrating an example of a second data augmentation parameter.

FIG. 9 is a diagram illustrating frequency distributions of data augmentation parameters in regard to each of classes of a target value.

### DETAILED DESCRIPTION

In Patent Literature 1, in order to design candidates of data augmentation parameters, knowledge relating to a task to be solved and properties of data is necessary. In addition, Patent Literature 1 discloses a method of designing a data augmentation parameter common to all data, and an optimal data augmentation parameter is not designed for each object sample. For example, in a class classification problem of a numeral image, no matter how much an image of “0” is rotated, the shape of the image remains “0”, and there is no need to restrict the rotational angle. On the other hand, if images of “6” and “9” are rotated over 180 degrees, distinction between “9” and “6” becomes impossible, and so there is a need to restrict the rotational angle for the purpose of distinction. In this manner, the knowledge relating to the task and data is necessary for the design of data augmentation, and data augmentation suitable for individual data should be designed.

Moreover, since Patent Literature 1 relates to a technology of adopting data augmentation that makes a score of augmented samples fall within a predetermined range from a score of other samples, it is not always possible to achieve “generalization of a target value prediction model” that is the very object of the data augmentation, by using the data augmentation.

A machine learning apparatus according to an embodiment includes an acquisition unit, a data augmentation unit, and a first training unit. The acquisition unit acquires a training sample including an object sample and a target value correlated with the object sample. The data augmentation unit generates a first augmented sample by applying data augmentation on the object sample in accordance with a first data augmentation parameter. The first training unit generates a parameter output function that inputs therein the object sample and outputs a second data augmentation parameter corresponding to the object sample, by machine learning based on the object sample, the target value and the first augmented sample.

Hereinafter, referring to the accompanying drawings, a machine learning apparatus, method and storage medium according to the embodiment are described.

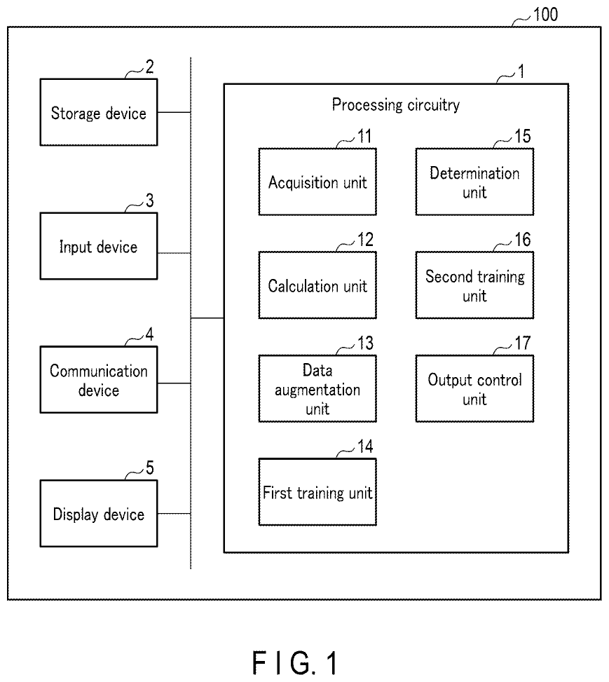

FIG. 1 is a diagram illustrating a configuration example of a machine learning apparatus 100 according to the embodiment. As illustrated in FIG. 1, the machine learning apparatus 100 is a computer including processing circuitry 1, a storage device 2, an input device 3, a communication device 4 and a display device 5. Data communication between the processing circuitry 1, storage device 2, input device 3, communication device 4 and display device 5 is executed via a bus or the like.

The processing circuitry 1 includes a processor such as a CPU (Central Processing Unit) or a GPU (Graphics Processing Unit), and a memory such as a RAM (Random Access Memory). By executing a program, the processing circuitry 1 implements an acquisition unit 11, a calculation unit 12, a data augmentation unit 13, a first training unit 14, a determination unit 15, a second training unit 16 and an output control unit 17. The program may be stored in a non-transitory recording medium that is readable by the processor. The program may be stored in a stationary recording medium such as the storage device 2, or may be stored in a portable recording medium. The hardware implementation of the processing circuitry 1 is not limited to the above mode. For example, the hardware may be constituted by an integrated circuit, such as an ASIC (Application Specific Integrated Circuit) or an FPGA (Field Programmable Gate Array), which implements the respective units 11 to 17. These units 11 to 17 may be implemented by a single integrated circuit, or may be individually implemented by a plurality of integrated circuits.

The acquisition unit 11 acquires a training sample including an object sample and a target value correlated with the object sample. The object sample means a data sample that is an object of processing, and is a data sample that is provided for machine learning on a parameter output function, a target value prediction model or the like to be described later. In one example, it is assumed that image data is used as the object sample. The target value means a teaching label in the machine learning of the target value prediction model.

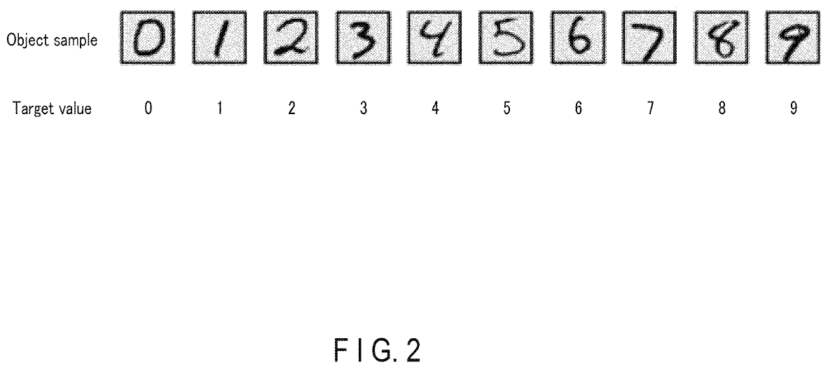

FIG. 2 is a diagram illustrating an example of the object sample and the target value. The object sample illustrated in FIG. 2 is a gray-scale image x∈R^{28×28} of 28×28 [pixel], in which only one of handwritten numerals of 0 to 9 is rendered. In a case where a task of the target value prediction model is an image classification, the target value is a label y∈[9] representing the numeral rendered in the object sample. For example, the target value of the object sample in which “0” is rendered is “0”. The acquisition unit 11 may acquire the object sample and the target value from some other computer, or from the storage device 2.

Note that the image data according to the present embodiment is not limited to the image data in which the handwritten numeral is rendered as illustrated in FIG. 2, and is applicable to any kind of image data. For example, the image data is applicable to an inspection image or the like, in which a photographic subject is a manufactured article in an inspection in a manufacturing process. For example, as the inspection image, use may be made of a semiconductor inspection image obtained by photographing a semiconductor manufactured in a semiconductor manufacturing factory by an electron microscope. In this case, the target value varies depending on the task of the target value prediction model, and, for example, in a case where the task of the target value prediction model is an image classification, the target value is the presence/absence of abnormality, the kind of abnormality or the like of a semiconductor product rendered in the inspection image.

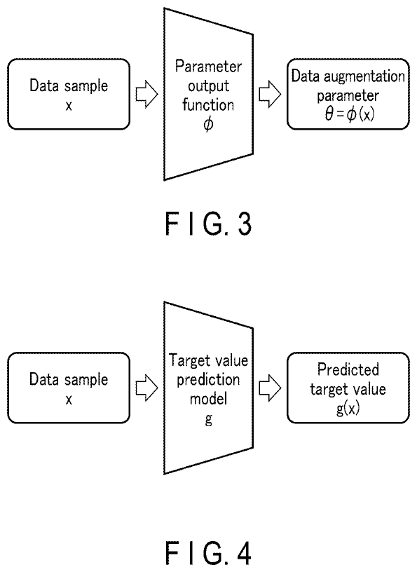

FIG. 3 is a diagram illustrating an input-output relationship of a parameter output function φ. As illustrated in FIG. 3, the parameter output function (inputs therein the data sample x∈R^{28×28} and outputs a data augmentation parameter θ. The data augmentation parameter θ has a dimension that varies depending on the kind of data augmentation. For example, as the data augmentation, if rotation, vertical parallel translation and horizontal parallel translation are executed for the image x, the data augmentation parameter θ is defined by a combination of a rotation parameter θᵣ∈R, a horizontal translation parameter θₕ∈R, and a vertical translation parameter θᵥ∈R. At this time, the transformation by the parameter output function φ can be expressed by formula (1) below.

$$ϕ \text{:} x ↦ [ {θ}_{r} , {θ}_{h} , {θ}_{v} ] \qquad ( 1 )$$

The parameter output function φ can be implemented by a machine learning model, to be more specific, a convolutional neural network of three layers. Note that the parameter output function φ may be a convolutional neural network of four or more layers. In addition, the parameter output function φ may include, in addition to the convolutional layers, other network layers such as a fully connected layer, a normalization layer, a pooling layer, and the like.

FIG. 4 is a diagram illustrating an input-output relationship of a target value prediction model g. As illustrated in FIG. 4, the target value prediction model g inputs therein a data sample x and outputs a predicted value (hereinafter “predicted target value”) g(x) of a target value. As the data sample x, an object sample, or a data sample (hereinafter “augmented sample”) generated by applying data augmentation to the object sample, is input. The predicted target value g(x) is a ten-dimensional vector including ten elements of numerals 0 to 9, and each element has a binary value of “1” indicating the relevance to the corresponding numeral or “0” indicating nonrelevance. At this time, the transformation by the target value prediction model g can be expressed by g: R^{28×28}→[0, 1]¹⁰. As the target value prediction model g, use may be made of a machine learning model, to be more specific, a neural network including three or more layers of network layers such as a convolutional layer, a fully connected layer, a normalization layer, and/or a pooling layer.

The calculation unit 12 calculates a first data augmentation parameter. The first data augmentation parameter is used in a learning aspect of the parameter output function. In one example, the calculation unit 12 calculates the first data augmentation parameter by applying a parameter output function, which is not completely trained, to the object sample.

The data augmentation unit 13 generates an augmented sample by applying data augmentation to the object sample in accordance with the data augmentation parameter. The augmented sample means the object sample to which data augmentation was applied. In one example, the data augmentation unit 13 generates the first augmented sample by applying data augmentation to the object sample in accordance with the first data augmentation parameter.

The first training unit 14 generates the parameter output function by machine learning based on an object sample, a target value correlated with the object sample, and a first augmented sample. The first training unit 14 trains the parameter output function in such a manner as to decrease a prediction error from the first augmented sample to the target value, while decreasing a similarity between the object sample and the first augmented sample.

The determination unit 15 calculates a second data augmentation parameter by applying a trained parameter output function to the object sample. The second data augmentation parameter means a data augmentation parameter that the trained parameter output function outputs. The determination unit 15 determines a third data augmentation parameter, based on the second data augmentation parameter, in regard to each of classes of the target values. The third data augmentation parameter means a data augmentation parameter for generating a second augmented sample that is used for training the target value prediction model.

The second training unit 16 generates a target value prediction model by machine learning based on the object sample, target value and second augmented sample. The second training unit 16 trains the target value prediction model in such a manner as to decrease a loss based on the predicted value and the target value.

The output control unit 17 outputs various information. The information may be displayed on the display device 5, may be output to an external device such as a computer via the communication device 4, or may be stored in the storage device 2. For example, the output control unit 17 outputs the parameter output function φr the target value prediction model.

The storage device 2 is constituted by a ROM (Read-Only Memory), an HDD (Hard Disk Drive), an SSD (Solid State Drive), an integrated circuit storage device, or the like. The storage device 2 stores various arithmetic operation results by the processing circuitry 1, various programs executed by the processing circuitry 1, and the like.

The input device 3 inputs various instructions from an operator. As the input device 3, use can be made of a keyboard, a mouse, various switches, a touch pad, a touch-panel display, or the like. An output signal from the input device 3 is supplied to the processing circuitry 1. Note that the input device 3 may be a computer connected to the processing circuitry 1 wiredly or wirelessly. Besides, the input device 3 may be a speech input device that converts the user's voice into an electric signal that can be processed by the processing circuitry 1.

The communication device 4 includes a communication interface, such as a network interface card (NIC), for executing information communication with an externa device that is connected to the machine learning apparatus 100 via a network.

The display device 5 displays various information in accordance with the control by the output control unit 17. As the display device 5, use can be made of, as appropriate, a CRT (Cathode-Ray Tube) display, a liquid crystal display, an organic EL (Electro Luminescence) display, an LED (Light-Emitting Diode) display, a plasma display, or a freely chosen display known in the technical field. The display device 5 may be a projector.

Hereinafter, the details of the machine learning apparatus 100 according to the present embodiment are described.

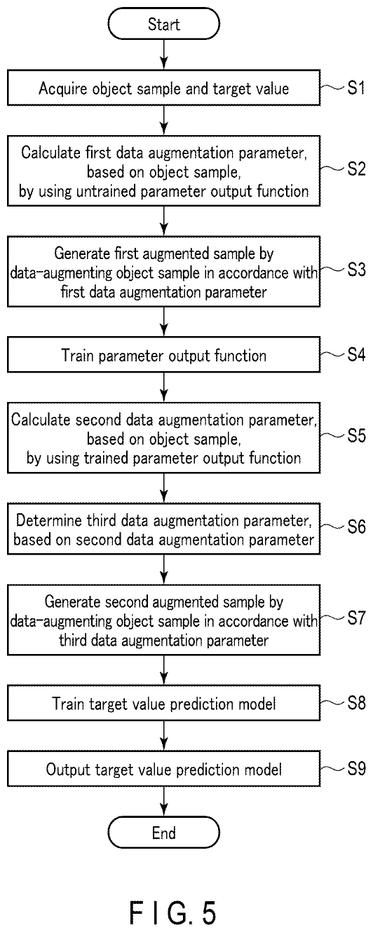

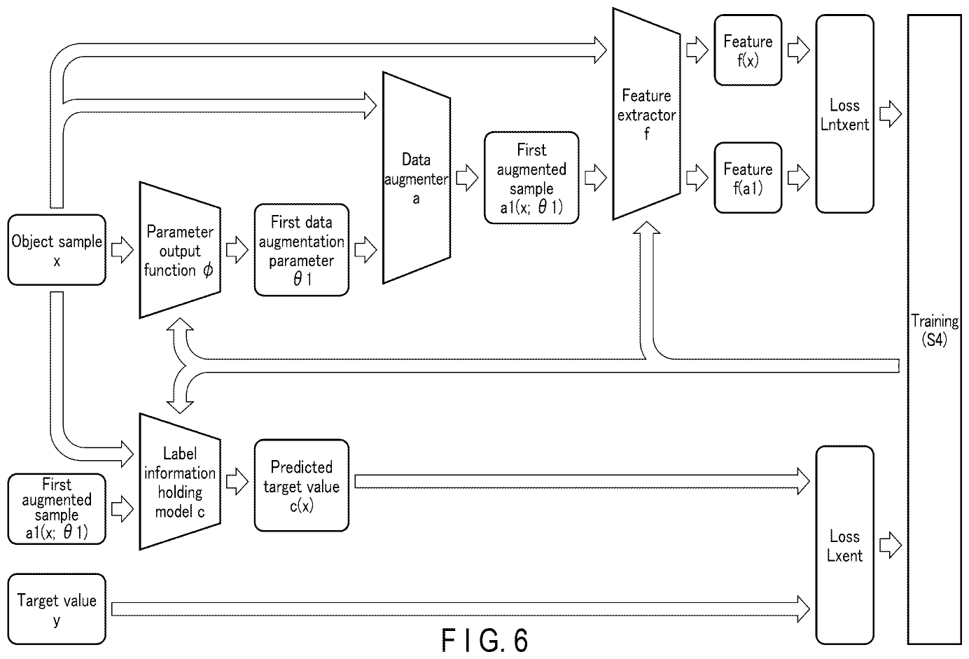

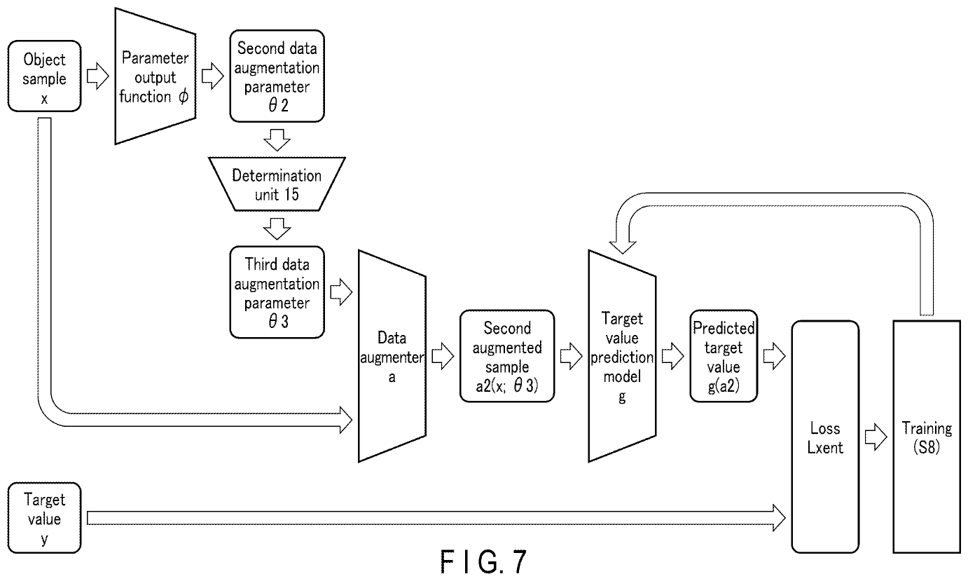

FIG. 5 is a diagram illustrating a processing procedure of a machine learning process according to the embodiment. FIG. 6 is a diagram schematically illustrating a training aspect of a parameter output function φ in steps S1 to S4 of FIG. 5. FIG. 7 is a diagram schematically illustrating a training aspect of a target value prediction model g in steps S5 to S8 of FIG. 5. In the embodiment below, it is assumed that the neural network illustrated in FIG. 3 is used as the parameter output function φ, and the neural network illustrated in FIG. 4 is used as the target value prediction model g. In addition, it is assumed that as the data augmentation, rotation, vertical parallel translation and horizontal parallel translation are executed for the image x, and the data augmentation parameter θ is defined by a combination of a rotation parameter θᵣ∈R, a horizontal translation parameter θₕ∈R, and a vertical translation parameter θᵥ∈R. Furthermore, it is assumed that the object sample x is an image in which any one of numerals “0” to “9” illustrated in FIG. 2 is rendered, and the target value is a label representing the numeral rendered in the object sample.

As illustrated in FIG. 5, the acquisition unit 11 acquires a training sample including an object sample x and a target value y (step S1). The number of training samples to be acquired is not particularly limited if the number is two or more.

If step S1 is executed, the calculation unit 12 determines a first data augmentation parameter θ1, based on the object sample x acquired in step S1, by using an untrained parameter output function φ (step S2). If step S2 is executed, the data augmentation unit 13 generates a first augmented sample a1 (x; θ) by data-augmenting the object sample x acquired in step S1, in accordance with the first data augmentation parameter θ1 determined in step S2 (step S3).

The data augmentation is executed by a data augmenter a that describes an image operation including rotation by an angle θr, vertical parallel translation θx and horizontal parallel translation θy of the object sample x. The data augmentation unit 13 generates a first augmented sample a1 by setting the data augmentation parameter θ1 in the data augmenter a and applying the object sample x to the data augmenter a. A mathematical expression of data augmentation for transforming coordinates (iₓ, i_{y}) of an original image x into coordinates (i′ₕ, i′ᵥ) of an augmented sample z (x; θ) is expressed by equation (2) below. Note that the value of the coordinates (iₓ, i_{y}) of the original image x is used as a pixel value of the coordinates (i′ₕ, i′ᵥ) of an augmented sample a(x). In a case where the coordinates are not integers, for example, use is made of a value obtained by linearly interpolating pixel values of four neighboring integer coordinates, or pixel values of integer coordinates that are closest in distance.

$$( \begin{matrix}{i}_{h}^{′} \\ {i}_{v}^{′}\end{matrix} ) = ( \begin{matrix}cos {θ}_{r} & - sin {θ}_{r} & {θ}_{x} \\ sin {θ}_{r} & cos {θ}_{r} & {θ}_{y}\end{matrix} ) ( \begin{matrix}{i}_{x} \\ {i}_{y} \\ 1\end{matrix} ) \qquad ( 2 )$$

If step S3 is executed, the first training unit 14 trains the parameter output function φ by the machine learning based on the object sample x acquired in step S1, the target value y acquired in step S1 and the first augmented sample a1(x; θ) generated in step S3 (step S4). In step S4, the first training unit 14 trains the parameter output function φ in such a manner as to decrease a prediction error from each of the object sample x and the first augmented sample a1 (x; θ) to the target value y, while decreasing a similarity between the object sample x and the first augmented sample a1 (x; θ). By training the parameter output function φ in this manner, the trained parameter output function φ can output the data augmentation parameter that minimizes the similarity between the generated augmented sample and the original sample, in such a range that the label correlated with the original sample can be predicted.

Specifically, as illustrated in FIG. 6, the first training unit 14 calculates a feature f(x) by applying the object sample x to a feature extractor f, calculates a feature f(a1) by applying the first augmented sample a1 to the feature extractor f, and calculates a loss Lₙₜₓₑₙₜ based on the feature f(x) and the feature f(a1). Specifically, as the feature extractor f, use is made of an encoder network that transforms a data sample into a feature of 256 dimensions. As the feature extractor f according to the present embodiment, a convolutional neural network of three layers, for example, is assumed. The transformation by the encoder network is represented by a mathematical expression such as f: R^{28×28}→R²⁵⁶. In this case, a normalized temperature cross entropy loss may be used as the loss Lₙₜₓₑₙₜ. Note that the dimension of the feature after the transformation by the feature extractor f is not limited to the 256 dimensions, and it suffices if the dimension is lower than the dimension of the object sample x.

In addition, as illustrated in FIG. 6, the first training unit 14 calculates a predicted target value c(x) by applying each of the object sample x and the first augmented sample a1 to a label information holding model c, and calculates a loss Lₓₑₙₜ based on the predicted target value c(x) and the target value y. As the label information holding model c, like the target value prediction model g, use is made of a neural network that transforms each of the object sample x and the first augmented sample a1 into the predicted target value c(x) of class classification. In one example, as the label information holding model c according to the present embodiment, a convolutional neural network of three layers is assumed. The predicted target value c(x), like the predicted target value g(x), is a ten-dimensional vector including ten elements of numerals 0 to 9, and each element has a binary value of “1” indicating the relevance to the corresponding numeral or “0” indicating nonrelevance. The transformation by the label information holding model c is represented by a mathematical expression like c: R^{28×28}→[0, 1]¹⁰. In this case, a cross entropy loss may be used as the loss Lₓₑₙₜ.

In step S4, the first training unit 14 trains the parameter output function φ, feature extractor f and label information holding model c in such a manner as to decrease the loss Lₙₜₓₑₙₜ in regard to the feature extractor f, and to increase the loss Lₙₜₓₑₙₜ, while decreasing the loss Lₓₑₙₜ, in regard to the parameter output function φ and label information holding model c. This training is represented by a mathematical expression as indicated by formula (3) below.

$${max}_{c , ϕ} {min}_{f} \{ {L}_{xent} - {L}_{ntxent} \} \qquad ( 3 )$$

The first training unit 14 executes stochastic gradient descent alternately in the minimization and maximization indicated in formula (3). The loss Lₙₜₓₑₙₜ and the loss Lₓₑₙₜ can be defined as indicated by equations (4) and (5) below, if a minibatch of the object sample sampled at random from a training data set is expressed by {xₙ}^{N}ₙ₌₁, the data augmentation thereof is expressed by {xₙ}^{2N}_{n=N+1}={φ(xₙ)}^{N}ₙ₌₁, and a label is expressed by {yₙ}^{N}ₙ₌₁. It should be noted, however, that zᵢ is an output f(xᵢ) from the feature extractor f, and c(x)_{y} is an yₙ+1-th element of the predicted target value c(x). In one example, setting is such that a minibatch size N=512, and a temperature parameter τ=1.

$${L}_{ntxent} = \frac{1}{2 N} {\sum }_{n = 1}^{N} [ ℓ ( k , N + k ) + ℓ ( N + k , k ) ] \qquad ( 4 )$$

$$ℓ ( i , j ) = - log \frac{exp cos ( {z}_{i} , {z}_{j} ) / τ}{{\sum }_{k \neq i} exp cos ( {z}_{i} , {z}_{k} ) / τ}$$

$${L}_{xent} = \frac{1}{2 N} {\sum }_{n = 1}^{N} - log {c ( {x}_{n} )}_{{y}_{n}} - log {c ( {x}_{n + N} )}_{{y}_{n}} \qquad ( 5 )$$

The training for the parameter output function φ, feature extractor f and label information holding model c is repeated by changing the content of the minibatch, until satisfying a predetermined repetition condition. The repetition condition may be set, for example, such that a predetermined number of times of repetition is reached. If the repetition condition is satisfied, step S4 is finished, and a trained parameter output function φ is generated. The trained parameter output function φ is stored in the storage device 2.

If step S4 is executed, the determination unit 15 calculates a second data augmentation parameter θ2, based on the object sample x acquired in step S1, by utilizing the trained parameter output function φ generated in step S4 (step S5). In step S5, the determination unit 15 prepares the object sample x with respect to each of classes of the target value y, and calculates the second data augmentation parameter θ2 by applying the trained parameter output function φ to the object sample x. Thereby, the second data augmentation parameter θ2 is obtained with respect to each of classes of the target value y.

As described above, the parameter output function φ is trained in such a manner as to decrease the prediction error from each of the object sample x and first augmented sample a1 to the target value y, while decreasing the similarity between the object sample x and the first augmented sample a1. Accordingly, the second data augmentation parameter θ2 calculated in step S5 has such a value that the similarity between the augmented sample generated based on the data augmented sample θ2 and the original sample becomes minimum within such a range that the label correlated with the original sample can be predicted.

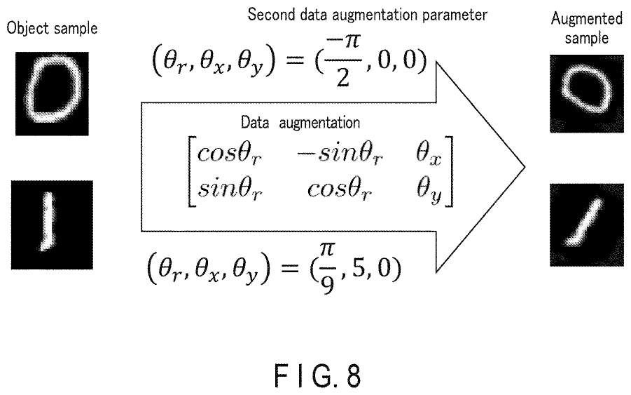

FIG. 8 is a diagram illustrating an example of the second data augmentation parameter θ2. As illustrated in FIG. 8, as indicated in the above equation (2), the data augmentation according to the present embodiment is expressed by the rotation with the angle θᵣ of the image x, the horizontal parallel translation θₓ and the vertical parallel translation θ_{y}. This data augmentation is expressed by the combination of three kinds of parameters of (θᵣ, θₓ, θ_{y}). In one example, the second data augmentation parameter of the object sample x of class “0” is (θᵣ, θₓ, θ_{y})=(−π/2, 0, 0). This represents the data augmentation in which, in regard to the image of class “0”, rotation is executed in a wide range of −90° to 0°, and neither vertical parallel translation nor horizontal parallel translation is executed. In another example, the second data augmentation parameter of the object sample x of class “1” is (θᵣ, θₓ, θ_{y})=(π/9, 5, 0). This represents the data augmentation in which, in regard to the image of class “1”, rotation is executed in a narrow range of 0° to 20°, horizontal parallel translation is executed between 0 pixel and 5 pixels, and vertical parallel translation is not executed.

The shape of the image of class “0” does not change, no matter how much the image is rotated, and if the image is vertically or horizontally parallel-translated, there is a tendency that the contour of “0” is broken off and the class information is lost. On the other hand, as regards the image of class “1”, if the image is rotated, the class information is lost. However, since there are margins on the left and right of this image, even if the image is parallel-translated, the contour thereof is not broken off, and there is a tendency that the class information is maintained. According to the present embodiment, without the need for such expertise, the data augmentation parameter (second data augmentation parameter), which is the limit for maintaining the class information, can automatically be obtained.

If step S5 is executed, the determination unit 15 determines a third data augmentation parameter, based on the second data augmentation parameter calculated in step S5 (step S6). In step S6, the determination unit 15 determines a third data augmentation parameter θ3, based on the frequency distribution of the second data augmentation parameter θ2, in regard to each of classes of the target value. In one example, the determination unit 15 samples a plurality of data augmentation parameters in a range between the second data augmentation parameter θ2 determined in step S5 and a reference value. The sampling may be executed in accordance with a random function φr another freely chosen function. The sampled data augmentation parameters are used as the third data augmentation parameter θ3. The sampling number may be set to a number that is necessary for training the target value prediction model g.

In one example, in the case of the image of class “0” of FIG. 8, as regards the data augmentation parameter θᵣ, sampling is executed between the second data augmentation parameter θ2 “−π/2” and a reference value “0”, and as regards the data augmentation parameters θₓ and θ_{y}, sampling is executed between the second data augmentation parameter θ2 “0” and the reference value “0”. In other words, as regards the data augmentation parameter θᵣ, the third data augmentation parameter θ3 has a value between “−π/2” and “0”, and as regards the data augmentation parameters θₓ and θ_{y}, the third data augmentation parameter θ3 has a value “0”. Similarly, in the case of the image of class “1” of FIG. 8, as regards the data augmentation parameter θᵣ, sampling is executed between the second data augmentation parameter θ2 “π/9” and the reference value “0”, and as regards the data augmentation parameter ex, sampling is executed between the second data augmentation parameter θ2 “5” and the reference value “0”, and as regards the data augmentation parameter θ_{y}, sampling is executed between the second data augmentation parameter θ2 “0” and the reference value “0”. In other words, as regards the data augmentation parameter θᵣ, the third data augmentation parameter θ3 has a value between “π/9” and “0”, as regards the data augmentation parameter ex, the third data augmentation parameter θ3 has a value between “5” and “0”, and as regards the data augmentation parameter θ_{y}, the third data augmentation parameter θ3 has a value “0”.

As described above, according to the present embodiment, since the third data augmentation parameter θ3 is determined from the second data augmentation parameter θ2, diverse data augmentation parameters can automatically be acquired while the class information is maintained, without the need for expertise of object samples. Note that the third data augmentation parameter θ3 is not necessarily determined in regard to each of all classes, and may be determined in regard to only some of all classes. Alternatively, the third data augmentation parameter θ3 may be determined in regard to each of groups into which all object samples are divided by an appropriate method.

If step S6 is executed, the data augmentation unit 13 generates a second augmented sample a2(x; θ3) by data-augmenting the object sample x acquired in step S1, in accordance with the third data augmentation parameter θ3 determined in step S6 (step S7). Specifically, the data augmentation unit 13 sets the third data augmentation parameter θ3 in the data augmenter a, and generates the second augmented sample a2 by applying the object sample x to the data augmenter a. The second augmented sample a2 is generated with respect to each of the third data augmentation parameters θ3 determined in step S6.

If step S7 is executed, the second training unit 16 trains the target value prediction model g by machine learning based on the target value y acquired in step S1 and the second augmented sample a2 determined in step S7 (step S8). In step S8, the second training unit 16 trains the target value prediction model g in such a manner as to decrease the loss between a predicted target value g(a2) acquired by applying the second augmented sample a2 to the target value prediction model g, and the target value y.

Specifically, as illustrated in FIG. 7, the second training unit 16 calculates the predicted target value g(a2) by applying the second augmented sample a2 to the target value prediction model g, and calculates the loss Lₓₑₙₜ that represents an error between the predicted target value g(a2) and the target value y. As the loss Lₓₑₙₜ, use may be made of a cross entropy based on the second augmented sample a2 and the target value prediction model g. Minimization of the loss Lₓₑₙₜ is represented by a mathematical expression as indicated by formula (6) below.

$${min}_{g} {L}_{xent} \qquad ( 6 )$$

Stochastic gradient descent may be used for the minimization of the loss Lₓₑₙₜ. The loss Lₓₑₙₜ can be defined as indicated by equation (7) below, if a minibatch of the object sample sampled at random from a training data set is expressed by {xₙ}^{N}ₙ₌₁, a label is expressed by {yₙ}^{N}ₙ₌₁. It should be noted, however, that g(a(x))_{y} is an yₙ+1-th element of the predicted target value g(a(x)). A minibatch size N is set at, for example, 512.

$${L}_{xent} = \frac{1}{N} {\sum }_{n = 1}^{N} - log {g ( a ( {x}_{n} ) )}_{{y}_{n}} \qquad ( 7 )$$

The training for the target value prediction model g is repeated by changing the content of the minibatch, until satisfying a predetermined repetition condition. The repetition condition may be set, for example, such that a predetermined number of times of repetition is reached. If the repetition condition is satisfied, step S8 is finished, and a trained target value prediction model g is generated.

If step S8 is executed, the output control unit 17 outputs the trained target value prediction model g generated in step S8 (step S9). The trained target value prediction model g is stored in the storage device 2.

By the above, the machine learning process by the machine learning apparatus 100 according to the present embodiment is terminated.

Various additions, changes and/or omissions may be made to the machine learning process illustrated in FIG. 6 as far as the spirit of the invention is not changed. Some modifications are described below.

### (Modification 1)

In the above embodiment, in step S6 of FIG. 5, the determination unit 15 was described as determining the third data augmentation parameter by sampling data augmentation parameters in the range between the second data augmentation parameter θ2 and the reference value. A determination unit 15 according to Modification 1 determines the third data augmentation parameter, based on the frequency distribution of the second data augmentation parameter θ2.

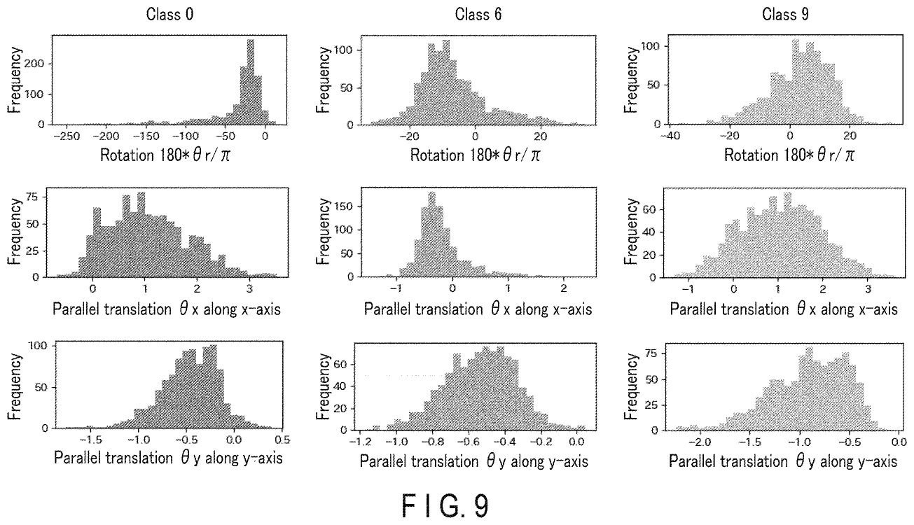

FIG. 9 is a diagram illustrating frequency distributions of data augmentation parameters in regard to each of classes of a target value. By way of example, as classes, “0” is illustrated in a left column, “6” is illustrated in a middle column, and “9” is illustrated in a right column. An upper row of FIG. 9 represents frequency distributions of a rotational angle 180×θᵣ/π in regard to each class, a middle row of FIG. 9 represents frequency distributions of a translation distance θₓ relating to an x-axis in regard to each class, and a lower row of FIG. 9 represents frequency distributions of a translation distance θ_{y} relating to a y-axis in regard to each class. The determination unit 15 obtain the data augmentation parameters by applying object samples to the trained parameter output function φ in regard to the respective classes. With respect to each of the classes of the target value, the determination unit 15 samples data augmentation parameters in a range between a maximum value and a minimum value of the data augmentation parameters in the frequency distribution. The sampling may be executed in accordance with a random function φr another freely chosen function. The sampled data augmentation parameters are used as the third data augmentation parameter θ3. The sampling number may be set to a number that is necessary for training the target value prediction model g.

For example, in the data augmentation for the object sample of class “0”, the rotation is executed over a wide range of a maximum value “+10°” to a minimum value “−230°”. On the other hand, in the data augmentation for the object samples of class “6” and class “9”, the rotation is executed in a limited range in which the classes can be distinguished, such as a range of a minimum value “−30°” to a maximum value “+30°”. According to Modification 1, since the third data augmentation parameter is determined from the range between the minimum value and the maximum value, diverse data augmentation parameters can automatically be acquired while the class information is maintained, without the need for expertise of object samples.

### (Modification 2)

In the above embodiment, the object sample was described as being the image data, but the present embodiment is not limited to this, and data samples of any kind of data format can be used. For example, as object samples, use can be made of, aside from image data, data samples of any data format, such as speech data, and time-sequential data of acceleration, voltage and the like.

### (Modification 3)

In the above embodiment, the data augmentation was described as the combination of rotation and parallel translation, but the embodiment is not limited to this and is applicable to any kind of modification. For example, in a case where the object sample is an image, affine transformation, addition of frequency noise, addition of a Gaussian filter, and the like are applicable as the data augmentation. In a case of a gray-scale image, as the data augmentation, luminance value transformation may be used, and, in a case of a color image, RGB value transformation may be used. In a case where the object sample is time-sequential data, transformation of a sampling rate, addition of frequency noise, addition of a Gaussian filter, and the like are applicable as the data augmentation.

### (Modification 4)

In the above embodiment, the first training unit 14 was described as using the normalized temperature cross entropy loss as the loss Lₙₜₓₑₙₜ, and using the cross entropy loss as the loss Lₓₑₙₜ, in order to decrease the prediction error to the target value, while making the feature of the augmented sample farther from the feature of the original object sample. However, as the loss Lₙₜₓₑₙₜ, use can be made of a freely chosen loss that quantifies the similarity between the augmented sample and the original object sample, such as a cosine similarity or a negative Euclidean distance. In addition, as the loss Lₓₑₙₜ, use can be made of a freely chosen loss that quantifies the distance between the predicted target value and the target value, such as a squared error, an absolute value error, a hinge loss, and the like.

### (Modification 5)

In the above embodiment, the first training unit 14 was described as simultaneously training the feature extractor and the label information holding model, as well as the parameter output function. However, the present embodiment is not limited to this. A first training unit 14 according to Modification 5 may use pre-trained models as the feature extractor and the label information holding model at the time of training the parameter output function.

In one example, as the feature extractor, use can be made of a freely chosen encoder network that is pre-trained by a freely chosen training data set. Since the similarity between the object sample and the augmented sample is calculated by the features of the encoder network, such data augmentation is implemented that a more deviation from the original object sample is achieved while the label is being maintained, by utilizing the feature extractor that extracts an input component to which attention is to be paid in the similarity calculation. In addition, in the training for the parameter output function, the training for the feature extractor can be omitted, and the training for the parameter output function can be quickened.

In one example, as the label information holding model, use can be made of a freely chosen class classifier that is pre-trained by a freely chosen training data set. Thereby, in the training for the parameter output function, the training for the label information holding model can be omitted, and the training for the parameter output function can be quickened.

### (Modification 6)

In the above embodiment, the second training unit 16 was described as training the target value prediction model g in such a manner as to decrease the loss Lₓₑₙₜ based on the predicted target value and the target value, as indicated in the above formula (6). A second training unit 16 according to Modification 6 trains the target value prediction model g in such a manner as to decrease the loss Lₓₑₙₜ in a case where an object sample with a large second data augmentation parameter is weighted by a greater value than an object sample with a small second data augmentation parameter. If the second data augmentation parameter θ2 obtained by applying the trained parameter output function φ to the object sample xₙ is expressed by φ(xₙ), the training by the second training unit 16 according to Modification 6 is represented by a mathematical expression as indicated by formula (8) below.

$${min}_{g} ( ϕ ( {x}_{n} ) {L}_{xext} ) \qquad ( 8 )$$

As described above, in the case where the second data augmentation parameter φ(xₙ) is large, since the third data augmentation parameter is sampled from the wide range, there are many variations of the second augmented sample generated in accordance with the third data augmentation parameter. Thus, by training the target value prediction model g in accordance with formula (8), the target value prediction model g can preferentially train the object sample with a large second data augmentation parameter, relative to the object sample with a small second data augmentation parameter.

### (Modification 7)

In the above embodiment, the second training unit 16 was described as training the target value prediction model by using all object samples, regardless of the value of the second data augmentation parameter. A second training unit 16 according to Modification 7 trains the target value prediction model by excluding object samples having second data augmentation parameters corresponding to outliers. With respect to each of classes of the target value, the second training unit 16 can determine outliers, based on the shapes of frequency distributions of the second data augmentation parameters according to Modification 1. In one example, the second training unit 16 may determine, as outliers, data augmentation parameters that deviate from predetermined quantiles such as quartile points. In addition, the second training unit 16 may calculate a plurality of second data augmentation parameters corresponding to a plurality of object samples, and may determine the outliers, based on a cluster analysis of the second data augmentation parameters. For example, the second data augmentation parameters, in connection with which the number of elements of clusters is less than a threshold, may be determined as outliners.

There is a strong possibility that an object sample having the second data augmentation parameter corresponding to the outlier is abnormal data. The second training unit 16 according to Modification 7 can improve the training accuracy and output accuracy of the target value prediction model, by excluding, from training objects of the target value prediction model, the object samples having the second data augmentation parameters corresponding to the outliers.

### CONCLUSION

As described above, the machine learning apparatus 100 according to the present embodiment includes the acquisition unit 11, data augmentation unit 13 and first training unit 14. The acquisition unit 11 acquires a training sample including an object sample and a target value correlated with the object sample. The data augmentation unit 13 generates a first augmented sample by applying data augmentation to the object sample in accordance with a first data augmentation parameter. The first training unit 14 generates a parameter output function that inputs therein the object sample and outputs a second data augmentation parameter corresponding to the object sample, by machine learning based on the object sample, the target value and the first augmented sample.

According to the above configuration, by training the parameter output function by using an individual object sample as a training sample, it becomes possible to generate the parameter output function that outputs an appropriate data augmentation parameter for the individual object sample. Thereby, the user can design a data augmentation parameter that can generate diverse augmented samples while maintaining the information of a target value, in accordance with the individual sample, without the need for high-level expertise of a task to be solved and an object sample.

Thus, according to the present embodiment, an appropriate data augmentation parameter for an individual object sample can be designed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A machine learning apparatus comprising processing circuitry, the processing circuitry being configured to:
acquire a training sample including an object sample and a target value correlated with the object sample;
generate a first augmented sample by applying data augmentation to the object sample in accordance with a first data augmentation parameter; and
generate a parameter output function that inputs therein the object sample and outputs a second data augmentation parameter corresponding to the object sample, by machine learning based on the object sample, the target value and the first augmented sample.

2. The machine learning apparatus of claim 1, wherein the processing circuitry is configured to train the parameter output function in such a manner as to decrease a prediction error from each of the object sample and the first augmented sample to the target value, while decreasing a similarity between the object sample and the first augmented sample.

3. The machine learning apparatus of claim 1, wherein the processing circuitry is configured to determine, based on the second data augmentation parameter, a third data augmentation parameter for generating a second augmented sample that is used for training a target value prediction model that inputs therein the object sample and outputs a predicted value of a target value corresponding to the object sample.

4. The machine learning apparatus of claim 3, wherein the processing circuitry is configured to determine the third data augmentation parameter, based on a frequency distribution of the second data augmentation parameter, in regard to each of classes of the target value.

5. The machine learning apparatus of claim 3, wherein the processing circuitry is configured to:
generate the second augmented sample by applying data augmentation in accordance with the third data augmentation parameter; and
generate the target value prediction model that inputs therein the object sample and outputs the predicted value, by machine learning based on the target value and the second augmented sample.

6. The machine learning apparatus of claim 5, wherein the processing circuitry is configured to train the target value prediction model in such a manner as to decrease a loss based on the predicted value and the target value.

7. The machine learning apparatus of claim 6, wherein the processing circuitry is configured to train the target value prediction model in such a manner as to decrease the loss in a case where the object sample with the second data augmentation parameter that is large is weighted by a greater value than the object sample with the second data augmentation parameter that is small.

8. The machine learning apparatus of claim 5, wherein the processing circuitry is configured to train the target value prediction model by excluding the object sample having the second data augmentation parameter corresponding to an outlier.

9. The machine learning apparatus of claim 1, wherein the first data augmentation parameter is a data augmentation parameter acquired by applying a parameter output function, which is not completely trained, to the object sample.

10. A machine learning method comprising:
acquiring a training sample including an object sample and a target value correlated with the object sample;
generating a first augmented sample by applying data augmentation to the object sample in accordance with a first data augmentation parameter; and
generating a parameter output function that inputs therein the object sample and outputs a second data augmentation parameter corresponding to the object sample, by machine learning based on the object sample, the target value and the first augmented sample.

11. A non-transitory computer readable medium including computer executable instructions, wherein the instructions, when executed by a processor, cause the processor to perform operations comprising:
acquiring a training sample including an object sample and a target value correlated with the object sample;
generating a first augmented sample by applying data augmentation to the object sample in accordance with a first data augmentation parameter; and
generating a parameter output function that inputs therein the object sample and outputs a second data augmentation parameter corresponding to the object sample, by machine learning based on the object sample, the target value and the first augmented sample.
